(19) United States
(12) Patent Application Publication
(10) Pub. No.: US 2023/0046128 A1
(43) Pub. Date: Feb. 16, 2023

(54) ON-CHIP BROADBAND BEAM POLARIZATION ROTATOR

(71) Applicant: B.G. NEGEV TECHNOLOGIES AND APPLICATIONS LTD., AT BEN-GURION UNIVERSITY, Beer Sheva (IL)

(72) Inventor: Alina KARABCHEVSKY, Lehavim (IL)

(73) Assignee: B.G. NEGEV TECHNOLOGIES AND APPLICATIONS LTD., AT BEN-GURION UNIVERSITY, Beer Sheva (IL)

(21) Appl. No.: 17/793,883

(22) PCT Filed: Jan. 19, 2021
(86) PCT No.: PCT/IL2021/050054

§ 371 Date: Jul. 19, 2022

Related U.S. Application Data
(60) Provisional application No. 62/963,199, filed on Jan. 20, 2020.

(51) Int. Cl. G02B 6/10; G02B 6/126

(52) U.S. Cl. CPC G02B 6/105; G02B 6/126

(57) ABSTRACT

The invention relates to a beam polarization rotator, which comprises: (a) a waveguide having an input facet, an output facet, and four side facets; (b) a core material of the waveguide having a first refractive index; (c) a coating material of the side facets having a refractive index lower than said refractive index of the core material; wherein the waveguide has a cuboid-twisted shape, such that a distal portion of an originally cuboid body is twisted at an angle α about a longitudinal-central axis of the waveguides body, while a proximal portion of the body remains fixed relative to said axis, resulting in said output facet be at an offset orientation angle α relative to the orientation of said input facet.

### FIELD OF THE INVENTION

The invention relates in general to the field of optical components. More specifically, the invention relates to the field of on-chip optical waveguides.

### BACKGROUND OF THE INVENTION

Passive optical waveguides are widely used for transferring optical signals between two physical locations. One type of such optical waveguides is the on-chip waveguide. A single semiconductor chip having an area of several cm² (or even less) can contain up to several hundreds of optical waveguides. Such chips are typically used in cameras, telescopes, multiplexers, devices that include on-chip laser, filters, light sources, amplifiers, and other optical devices.

A beam polarization rotator is vital when combining integrated photonic circuits with optical fibers or laser beams. Integrated photonics are widely applied in data communication, photonic interconnects, telecommunication, specialized signal processing, imaging, displays, electronic warfare, medical diagnosis, optical logic, and several on-chip technologies, such as spectrometers and photonic sensors of chemical, biological, and physical variables. The current trend of integrated photonics moves towards smaller device dimensions and improved cost-efficiency. Ultra-compact integrated photonic devices and circuits have a footprint of a few square microns. They are also made of Complementary Metal-Oxide Semiconductor (CMOS), compatible with standard microelectronic technology facilities, which allows for large-scale integration and low-cost fabrication, and easy convergence with electronic systems. Analogous to the power supply in electrical systems, an integrated photonic system is an essential aspect of the laser, which, in turn, serves as the optical power supply. Keeping the laser off-chip, separated from the integrated photonic components, has several advantages: thermal management is simpler; highly efficient lasers with high output, bandwidth, and yield are already commercially available; and the laser light can be delivered to the chip using fiber optics. However, matching the laser beam shape to the guided mode profile (electromagnetic fields guided in waveguide core) is essential to obtain maximum coupling efficiency to the optical system.

A practical approach for matching the laser output beam and optical modes shapes uses optical elements to rotate the laser's beam. Commercially available polarization rotators, referred to as beam twisters, can be purchased from vendors such as Edmund Optics and FISBA. These beam twisters are replicated reflow lenses, composed of patterned structures etched on both sides of a float-glass substrate. Both twisters claim a transmission efficiency greater than 97%, operating in the visible/near-IR wavelength spectrum. However, these glass blocks have dimensions of roughly 3×3×12 millimeters. In the scale of micro-electro-mechanical devices (i.e., lab-on-a-chip systems), this is a massive size. One type of traditional polarization flipping device includes a prism that geometrically manipulates the light through several reflections. The spectral range of this traditional device depends on the reflecting material and is sensitive to misalignment. Prisms are also used to rotate the polarization field. Another structure for rotating the polarization uses birefringent uniaxial crystalline materials, where ordinary and extraordinary rays propagate in different velocities. However, such birefringent rotators are wavelength-specific and cannot be used in broadband applications. Recent proposals for compact polarization rotation include (1) triangular waveguides in an InP membrane; (2) utilization of surface plasmon polaritons; (3) asymmetric directional couplers using an augmented low-index guiding waveguide; and (4) photonic crystals with an anisotropic design or with a physical twist introduced in a photonic crystal fiber. However, these polarization rotators suffer from one or more of the following drawbacks: (1) they are incapable of beam polarization rotation in broad spectral range; (2) their structures are complicated; and (c) their dimensions are too large for on-chip use.

It is an object of the invention to provide a beam polarization rotator compatible with on-chip integration.

It is an additional object of the invention is to provide said on-chip beam polarization rotator, having broadband and multi-mode capabilities.

It is still another object of the invention to provide said on-chip beam polarization rotator that can operate with high efficiency and minimal losses.

It is still another object of the present invention to provide the above beam polarization rotator in the form of an on-chip waveguide.

It is still another object of the invention to provide an on-chip beam polarization rotator, which is compact and relatively simple to manufacture.

Other objects and advantages of the invention will become apparent as the description proceeds.

### SUMMARY OF THE INVENTION

The invention relates to a beam polarization rotator, which comprises: (a) a waveguide having an input facet, an output facet, and four side facets; (b) a core material of the waveguide having a first refractive index; (c) a coating material of the side facets having a refractive index lower than said refractive index of the core material; wherein the waveguide has a cuboid-twisted shape, such that a distal portion of an originally cuboid body is twisted at an angle α about a longitudinal-central axis of the waveguides body, while a proximal portion of the body remains fixed relative to said axis, resulting in said output facet be at an offset orientation angle α relative to the orientation of said input facet.

In an embodiment of the invention, the twist spans a portion or the waveguide's entire length.

In an embodiment of the invention, a is in the range between 0° to 360°.

In an embodiment of the invention, the beam polarization rotator is buried within a chip's integrated circuit.

In an embodiment of the invention, the beam polarization rotator is made from materials selected from silica, borosilicate glasses, or polymers.

In an embodiment of the invention, the beam polarization rotator has a length in the order of several hundreds of μm.

In an embodiment of the invention, the length of the portion of twist is in the order of several hundreds of μm, equal or shorter than the entire length of the beam rotator.

In an embodiment of the invention, the dimensions of the input and output facets are in the order of several μm or larger.

In an embodiment of the invention, the beam polarization rotator has a bandwidth up to 500 nm.

### BRIEF DESCRIPTION OF THE DRAWINGS

In the drawings:

FIG. 1 generally shows a typical prior art cuboid on-chip optical waveguide;

FIG. 2 shows a general structure of a beam polarization rotator, according to an embodiment of the invention;

FIGS. 3a-3d show the influence of the twisted waveguide's length on the propagation field;

FIG. 4a is a curve showing how overlap between the output field and the input mode becomes larger as the twisted length increases;

FIG. 4b shows the overlap between the output field and the input mode with a twist length of 600 μm, at a wavelength range of 1.2 μm-1.7 μm;

FIGS. 5a-5c show an electric field intensity of a wavelength beam of 1.55 μm, as it propagates along a 90° twisted 20×4 μm waveguide; and

FIG. 6 shows the propagation of power losses relative to the length of a twisted 45° waveguide.

### DETAILED DESCRIPTION OF PREFERRED EMBODIMENTS

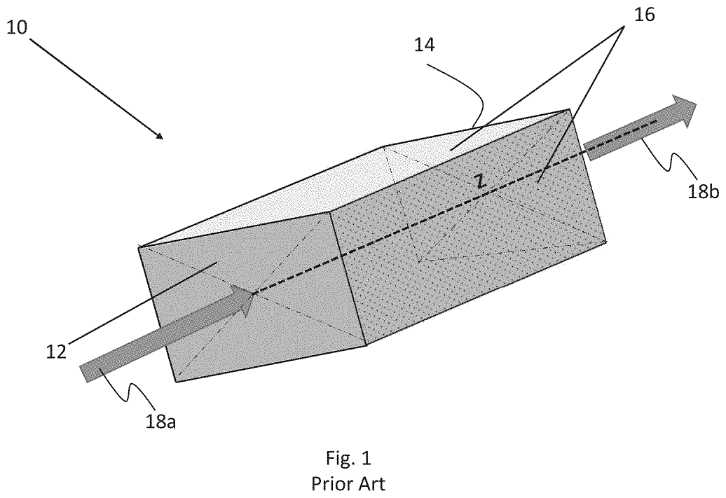

A typical prior art cuboid on-chip optical waveguide 10 is generally shown in FIG. 1. The waveguide has an input facet 12, an output facet 14, and a plurality of side facets 16 (the term “side facets” refers herein inclusively to the top, bottom, right, and left-side facets). The waveguide's core is typically made of a material having a relatively high refractive index in optical frequencies, such as silicon, silicon-nitride, gallium-arsenide, silica (silicon dioxide), borosilicate compatible with conventional optical fibers. The side facets 16 are generally coated by an outer cladding layer, a material with a lower refractive index than the core. As shown, the input facet 12 and similarly the output facet 14 (not seen) have a rectangular shape. As the waveguide 10 has a pure cuboid shape, the rectangular input facet 12 and the rectangular output facet 14 have the same orientation relative to a longitude-central axis Z passing through both of their centers. Typically, when a polarized optical beam 18a arrives at input facet 12 of the waveguide, the beam propagates through the waveguide's core and leaves the waveguide from output facet 14 as beam 18b, keeping the same direction and polarization of input beam 18a. If the input beam includes several mode shapes, the mode shapes are generally also maintained at the output beam 18b.

There are many situations in which a necessity arises for altering the output beam's polarity compared to the input beam's polarity. For this purpose, various types of beam polarization rotators have been proposed by the prior art. However, all these prior art beam polarization rotators suffer from one or more of the following drawbacks: (1) they are incompatible for production from materials that are commonly used in the microelectronics industry; (2) they have dimensions that are too large for on-chip integration; (3) they are wavelength-specific, namely, incompatible for broadband operation; (4) they are clumsy and require alignment (sometimes even frequent realignments) to rotate the beam, while accurately preserving characteristics, such as, field brightness, coherence, etc.).

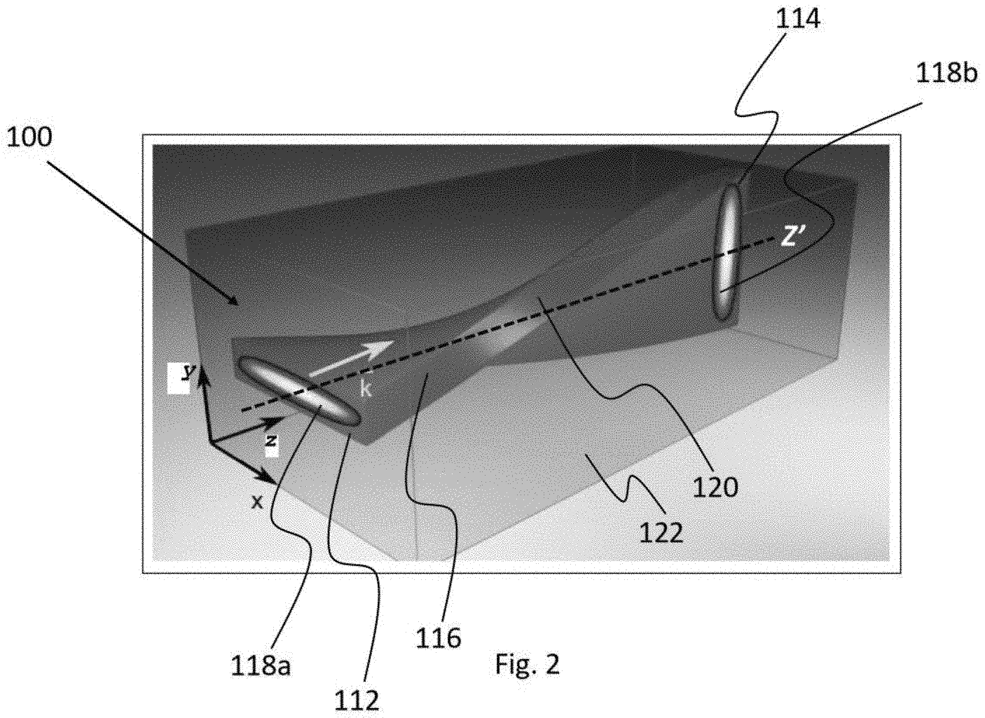

FIG. 2 shows a general structure of a beam polarization rotator 100, suitable for on-chip integration, according to an embodiment of the invention. Beam polarization rotator 100 has a twisted-cuboid shape and is substantially made from the same materials as the prior art waveguide 10 of FIG. 1. In similarity to the prior art waveguide 10 of FIG. 1, beam rotator 100 has a rectangular input facet 112, a rectangular output facet 114, and four side-facets 116. However, while the input and output facets, 12 and 14 respectively of the prior art waveguide 10 (of FIG. 1) have the same orientation relative to a longitudinal-central axis Z (as is the case with any pure cuboid body), the output facet 114 of the beam polarization rotator 100 of the present invention is twisted (in this specific case 90°) about a longitudinal-central axis Z′ relative to the input facet 112. More specifically, beam rotator 100 is made of a twisted waveguide where the output facet's orientation is rotated about a central-longitudinal axis Z′ relative to the input facet's orientation. The inventors have found that by twisting the waveguide gradually along a portion or all the waveguide's length, the beam's polarization follows the waveguide's contour, including the twist, altering the polarization of the output beam 118b at the output facet, respectively. In this specific case, a polarization rotation of 90° relative to the polarization of the input beam 118a is shown. Various other angular polarization rotations a can be made according to a respective level of the waveguide's twist. Given the invention's waveguide's asymmetrical structure, it is preferable to provide support for maintaining it. In FIG. 2, waveguide 100 is shown within a supporting glass chamber 122. Other types of support may be used.

The polarization rotator of the invention can be embedded within an integrated circuit. It can be fabricated, for example, from polymers. It can also be fabricated from materials compatible with the optical fibers communications industry, such as silica and borosilicate glasses. The beam rotator's dimensions can be miniaturized to dimensions suitable in the microelectronics industry. For example, dimensions of the input and output facets can be as small as a few μm (20 μm×4 μm facets were investigated), and the length of the waveguide may be as small as several hundreds of micrometer (waveguide lengths of 200 μm, 400 μm, and 600 μm were investigated). Larger or somewhat smaller dimensions than specifically investigated are expected to be applicable as well. Many beam rotators of the invention, for example, between 1 and tens, may be included in a single integrated circuit.

A variety of polarization alterations in a range between 0° and 360° can be obtained by suitably twisting the waveguide accordingly (alteration of 45° and 90°, and various other angle were investigated and were found applicable). The region of twisting may occupy the whole waveguide's length. Alternatively, the twisting region may occupy only a portion of the waveguide's length, such that the remaining portions of the waveguide may go straight. Preferably, the twisting region's length is longer than 350 μm; however, a shorter twisting region may be suitable in some cases. Furthermore, the beam rotator of the invention is a broadband rotator in bandwidth ranging between a single wavelength and a few hundreds of nm. The inventors have demonstrated bandwidth of 500 nm.

The waveguide of the invention may be fabricated using 3D printing technology or two-photon absorption technology. Starting from a general “straight” waveguide shape as in FIG. 1, the waveguide's twisting can also be performed by use of, for example, a UV beam. Commonly used technology and machinery that can be used for fabricating the waveguide of the invention appears, for example, in (i) “Adaptive Optics in Laser Processing”, Patrick S. Salter et al., Light: Science & Applications 8, Article number: 110 (2019); and (ii) “Aberration Correction for Direct Laser Written Waveguides in A Transverse Geometry”, L. Huang, et al., Optics Express 10565, 16 May 2016, Vol. 24, No. 10.

The twisted waveguide of the invention can be used to polarization-encode information in photonic integrated circuits. The twisted waveguide of the invention can also be used to control polarization states or in cases when a combination of polarization isolator, polarization rotator, etc., is necessary.

While the art has provided various structures for implementing polarization manipulation in free space, on-chip polarization conversion using integrated waveguides has not been provided for broadband operation. As will be shown, the invention provides a novel 3D waveguide for on-chip polarization manipulation functionalities.

### EXAMPLES AND FURTHER DISCUSSION

In a waveguide with a uniform cross-section, modes included in the beam are orthogonal to each other. Hence, when launching a multi-mode beam through a waveguide, power is supposed not to couple between different modes. However, when perturbation occurs in the waveguide, the orthogonality is disturbed, sometimes lost, and modes couple to each other, leading to power transfer between modes. The power can also be coupled to radiation modes caused by the perturbation, namely those that do not propagate through the waveguide, resulting in a propagation loss. The twist in the waveguide is designed to be long enough to minimize propagation losses to the substrate due to the twist-related radiation while maintaining the twisted waveguide's adiabaticity. Moreover, a long-enough twist-region causes ant significant non-uniformity along the waveguide to vary slowly. The inventors have used local-mode coupling theory to estimate a preferable twist length.

For a weakly guiding, the coupling coefficient between mode j and mode l is defined as:

$${C}_{jl} = - \frac{{n}_{co}}{2} {( \frac{{ε}_{0}}{{μ}_{0}} )}^{1 / 2} \frac{τ}{N} {\int }_{{A}_{∞}} {Ψ}^{2} dA = τ ( z ) \qquad ( 1 )$$

Assume a weak power transfer due to a small rate of twist and a low-index contrast

|τ(z)|<<|β₁-β₂| (2)

Where τ(Z) is the rate of twist, and β is the propagation constant of the mode.

The minimum distance for a π/2 rotation (90°) is given by

$${Z}_{b} ≫ \frac{π}{2 τ ( Z )} \qquad ( 3 )$$

$${Z}_{b} ≫ \frac{π}{2 \vert {β}_{1} - {β}_{2} \vert} \qquad ( 4 )$$

It has been found that a twist length larger than 2 mm is preferable for a substantially lossless power transfer.

FIG. 2 shows a 90° twisted waveguide structure suitable for twisting a beam's polarization by 90°. A numerical simulation was performed to investigate this structure and to determine an optimal twist length. A BeamPROP—Beam Propagation Method (BPM) software was used to carry out this investigation. The inventors studied a buried rectangular waveguide having dimensions of 20×4 μm with an output facet rotated by 90° relative to the input facet, and simulated the structure at a wavelength of 1.55 μm. The waveguide core had a refractive index of 1.51, and the surrounding medium had a refractive index of 1.5. These parameters are similar to those of a commonly buried waveguide within a substrate having glass properties. The boundaries were defined as a Perfectly Matched Layer (PML) to prevent scattering back to the waveguide's core.

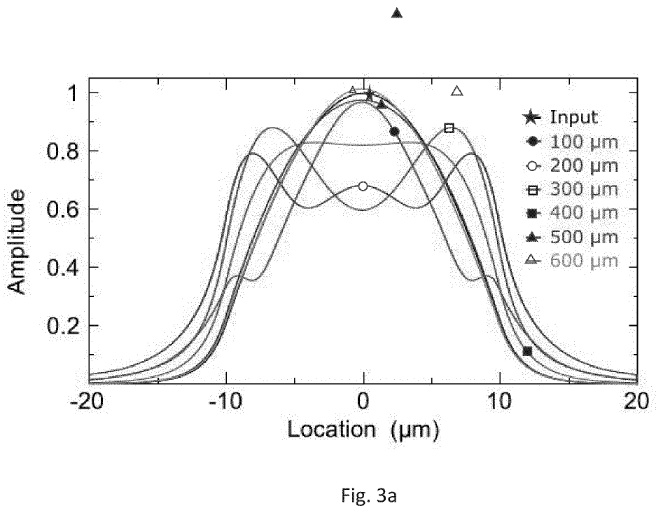

The twisting region's length has been found to be important in the structure of the beam polarization rotator of the invention. The length of the twist significantly influences the rotation losses that appear as scattering from the guiding layer. A shorter waveguide has more losses than a more elongate waveguide, while a too long waveguide may not fit a chip's dimensions. Multiple waveguide lengths, namely 100-600 μm (with intervals of 50 μm) were simulated to determine an optimal length. FIG. 3a shows a cross-section of a field in the investigated twisted waveguide's output for different lengths than the cross-section of a fundamental mode. Also, less power is coupled to higher-order modes when the twisted waveguide becomes longer, as can be seen in the length of 500 μm. FIG. 3a shows a cross-section of an output field at the center of the waveguide in a 20×4 μm waveguide, at a wavelength of 1.55 μm, for a 90° rotation, for different twisted waveguide lengths. FIGS. 3b-3d show the field intensity at the output facet for different waveguide lengths of 200 μm, (c) 400 μm and 600 μm, respectively. The inventors found that a twisted waveguide having a length of 600 μm has lower scattering compared to a shorter waveguide, as shown in FIGS. 3b-3d. Also, FIGS. 3a-3d show the influence of the twisted waveguide length on the propagation field. In a longer twisted waveguide (FIG. 3d), the field shape is very similar to the input mode. However, when the twisted waveguide is shorter, the field shape changes and shows a little twitch in the edges, as can be seen in the 200 μm waveguide (FIG. 3b).

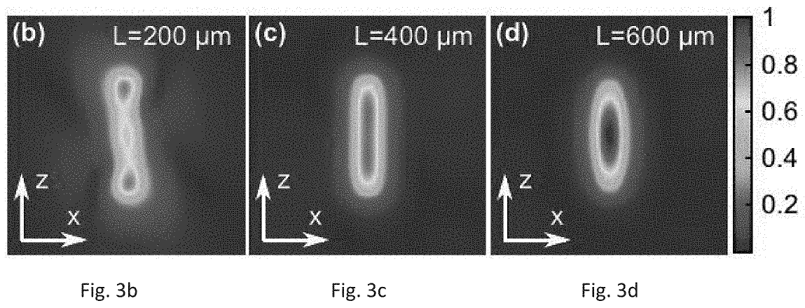

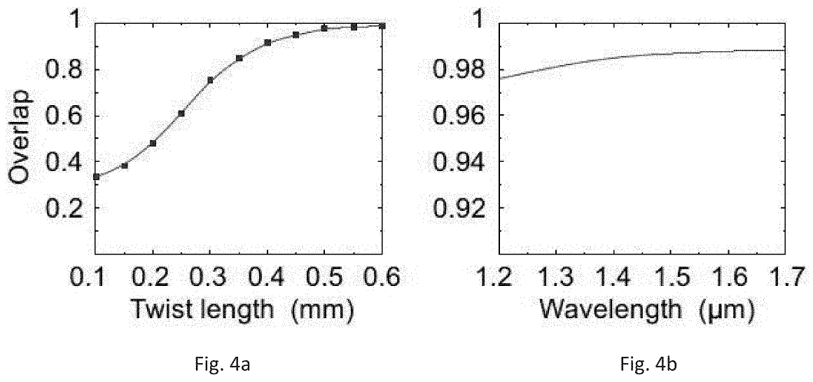

After finding the optimal length, the waveguide's guiding layer was rotated by 90° for different lengths of the twisted waveguide, while the input is the fundamental mode. To determine the mode rotator's efficiency, the inventors calculated the overlap between the output field and the input mode. The output field overlapped with the input mode by rotating it by 90° using BeamPROP. FIG. 4a shows how overlap between the output field and the input mode becomes larger as the twisted length increases. The increase at the curve means that the power stays in the fundamental mode and does not couple with the other modes, which means that the twist is slow enough. FIG. 4b shows the overlap between the output field and the input mode with a twist length of 600 μm at a wavelength range of 1.2 μm-1.7 μm. The overlap stays nearly constant as a function of the wavelength and decreases just a little around 1.2 μm.

The inventors also investigated the influence of the twist on higher-order modes. Higher-order modes possess a more considerable overlap integral with the medium above the waveguide. Also, for telecommunication applications, when more than one message needs to be transferred, there is a requirement for additional modes to co-exist in the same device without inter-coupling with each other. The inventors simulated the twisted waveguide of the invention with different input mode-orders.

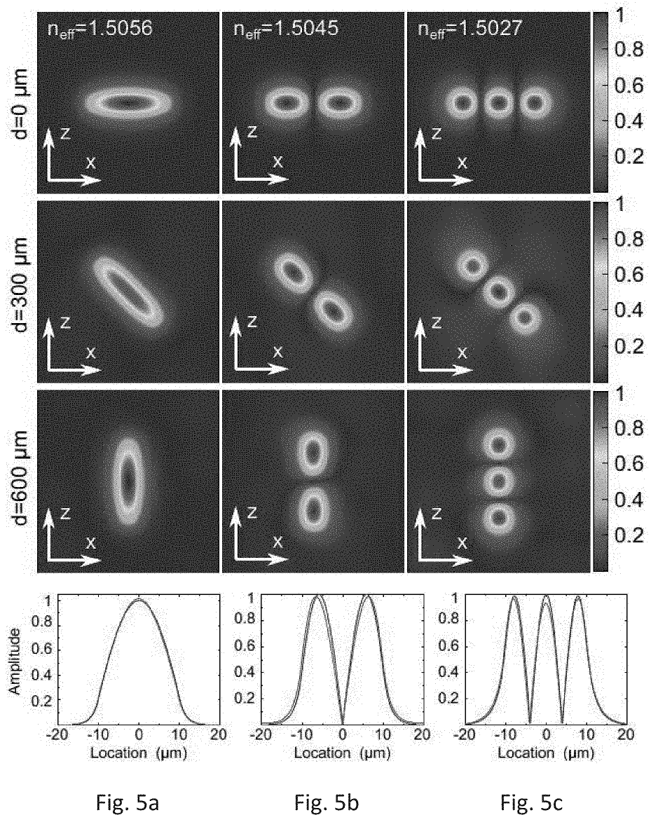

FIGS. 5a-5c show an electric field intensity of a wavelength beam of 1.55 μm, as it propagates along a 90° twisted 20×4 μm waveguide at (i) the input (d=0 μm), (ii) the center (d=300 μm) and (iii) the output (d=600 μm). Each column corresponds to a different mode order; FIG. 5a fundamental; FIG. 5b second; and FIG. 5c third. The bottom row shows the field's cross-section for the input and the output in the center of the waveguide for different input mode orders. Each column corresponds to different mode order, namely, fundamental, second, and third. It shows that the mode shape is preserved when the multi-mode beam propagates and rotates through the waveguide. The bottom row of FIGS. 5a-5c shows a cross-section of the field for the input and output for different input mode orders. It shows that the cross-section of the field stays nearly the same for each order of modes.

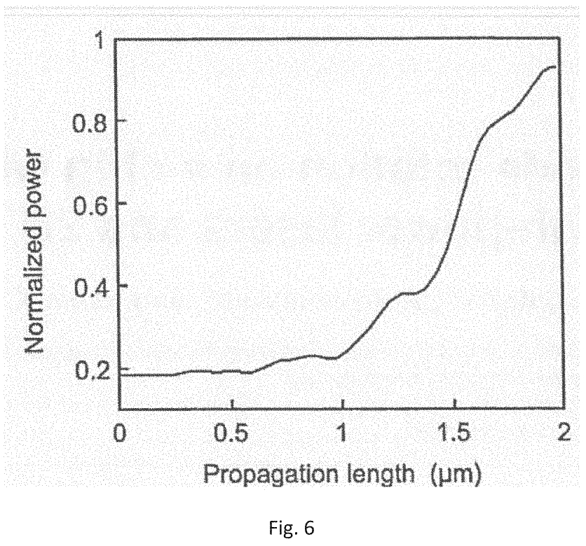

In another numerical analysis, the inventors also found that a 2000 μm length waveguide has lower scattering losses than a shorter waveguide, as shown in FIG. 6. For a waveguide rotated by 45° having a length of 2000 μm, a transmission efficiency of 92% was obtained at the output facet for a beam's fundamental mode. The inventors also found that this twisted-structure of the invention preserves higher-order modes.

While some embodiments of the invention have been described by way of illustration, it will be apparent that the invention can be carried into practice with many modifications, variations, and adaptations, and with the use of numerous equivalent or alternative solutions that are within the scope of persons skilled in the art, without departing from the spirit of the invention or exceeding the scope of the claims.

1. A beam polarization rotator, comprising:
a waveguide having an input facet, an output facet, and four side facets;
a core material of the waveguide having a first refractive index; and
a coating material of the side facets having a refractive index lower than said refractive index of the core material;
wherein said waveguide has a cuboid-twisted shape, such that a distal portion of an originally cuboid body is twisted at an angle α about a longitudinal-central axis of the waveguides body, while a proximal portion of the body remains fixed relative to said axis, resulting in said output facet be at an offset orientation angle α relative to the orientation of said input facet.

2. A beam polarization rotator according to claim 1, wherein said twist spans a portion or the entire length of the waveguide.

3. A beam polarization rotator according to claim 1, wherein a is in the range between 0° to 360°.

4. A beam polarization rotator according to claim 1, which is buried within a chip's integrated circuit.

5. A beam polarization rotator according to claim 1, which is made from materials selected from silica, borosilicate glasses, or polymers.

6. A beam polarization rotator according to claim 1, having a length in the order of several hundreds of μm.

7. A beam polarization rotator according to claim 2, wherein the length of said portion of twist is in the order of several hundreds of μm, equal or shorter than the entire length of the beam rotator.

8. A beam polarization rotator according to claim 1, wherein the dimensions of the input and output facets are in the order of several μm or larger.

9. A beam polarization rotator according to claim 1, having a bandwidth up to 500 nm.
